(19) United States
(12) Patent Application Publication
(10) Pub. No.: US 2025/0351825 A1
(43) Pub. Date: Nov. 20, 2025

(54) AGRICULTURAL COMPOSITIONS FOR PROTECTING PLANTS AGAINST ABIOTIC STRESSORS

(71) Applicant: Spogen Biotech Inc., St. Louis, MO (US)

(72) Inventors: Johanna C. Bailey, Eau Claire, WI (US); Brian M. Thompson, Creve Coeur, MO (US)

(21) Appl. No.: 19/209,935

(22) Filed: May 16, 2025

Related U.S. Application Data
(60) Provisional application No. 63/648,971, filed on May 17, 2024.

(51) Int. Cl. A01N 37/36; A01N 25/02; A01N 37/28; A01N 43/36; A01N 43/50; A01N 43/52; A01N 43/54; A01N 59/00; A01P 21/00

(52) U.S. Cl. CPC A01N 37/36; A01N 25/02; A01N 37/28; A01N 43/36; A01N 43/50; A01N 43/52; A01N 43/54; A01N 59/00; A01P 21/00

(57) ABSTRACT

Agricultural compositions are provided which comprise 1) citric acid and polyethylene glycol and/or sodium bicarbonate, or 2) sodium citrate. The compositions are used for improving seed germination and drought tolerance and cold temperature exposures in plants, which grew out of treated seeds.

### CROSS REFERENCE TO RELATED APPLICATIONS

This application claims the benefit of U.S. Application No. 63/648,971, filed May 17, 2024, the content of which is incorporated herein by reference in its entirety.

### FIELD OF THE INVENTION

The invention relates to agricultural compositions comprising citric acid and polyethylene glycol and/or sodium bicarbonate to extend the life of plant seeds and/or to promote drought tolerance, cold tolerance, and/or germination in plants and plant seeds. The agricultural compositions can alternatively comprise sodium citrate. Methods of using these agricultural compositions in plant seeds and/or plants are further provided.

### BACKGROUND OF THE INVENTION

Abiotic factors such as water access and temperature can cause significant damage to agricultural crops and ornamental plants (such as through drought and cold temperatures), leading to substantial economic loss. Such abiotic factors impact all types of plant tissue and can impact large amounts of crops in a single geographic region. A number of strategies are currently available and have been deployed to protect plants, plant seeds, and plant yield from the impacts of abiotic factors, such as genetic editing of plants to alter genes and gene expression to promote water retention, drought resistance, temperature endurance, and freeze tolerance. However, these strategies are labor intensive and require large amounts of research for each individual agriculturally relevant crop and ornamental plant of interest. Furthermore, recent studies of environmental forecasts project the frequency and intensity of natural events impacting availability of critical resources for plants, such as water, to increase. In addition, the effects of anthropogenic climate change are leading to less predictable weather patterns, including extreme cold temperatures, which can impact seed germination, sprouting time, growth, and yield of agricultural crops. For example, in the event of cold temperatures following seed sowing, seeds absorb water but do not germinate below certain temperatures, leading to increased opportunity for seed rot and disease, poor seedling vigor, and reduced germination. The combination of time- and labor-intensive solutions, and an accelerated timeline for climate change is driving the need for a solution that has broad application and is readily available and deployable.

### SUMMARY OF THE INVENTION

An aspect of the invention is directed to an agricultural composition for protecting a plant, plant part, and/or plant seed from cold temperatures, drought conditions, and/or promoting germination wherein the composition comprises:
citric acid having a weight percentage in a range from about 0.2% to about 0.4% based on the total weight per volume (w/v) of the composition; and either one or both of the following: polyethylene glycol having a weight percentage in a range from about 4.0% to about 5.0% based on the total weight per volume (w/v) of the composition; and/or sodium bicarbonate having a weight percentage in a range from about 0.01% to about 0.10% based on the total weight per volume (w/v) of the composition.

The agricultural composition can further comprise a pesticide, a preservative, a seed fluency agent, a biopolymer, or a combination thereof.

Another aspect of the invention is the provision of an agricultural composition for protecting a plant, plant part, and/or plant seed from cold temperatures, drought conditions, and/or promoting germination wherein the composition consists essentially of:
citric acid having a weight percentage in a range from about 0.2% to about 0.4% based on the total weight per volume (w/v) of the composition; and either one or both of the following:
polyethylene glycol having a weight percentage in a range from about 4.0% to about 5.0% based on the total weight per volume (w/v) of the composition; and/or sodium bicarbonate having a weight percentage in a range from about 0.01% to about 0.10% based on the total weight per volume (w/v) of the composition.

Still another aspect of the invention is the provision of an agricultural composition for protecting a plant, plant part, and/or plant seed from cold temperatures, drought conditions, and/or promoting germination, wherein the composition consists of:
citric acid having a weight percentage in a range from about 0.2% to about 0.4% based on the total weight per volume (w/v) of the composition; and either one or both of the following:
polyethylene glycol having a weight percentage in a range from about 4.0% to about 5.0% based on the total weight per volume (w/v) of the composition; and/or sodium bicarbonate having a weight percentage in a range from about 0.01% to about 0.10% based on the total weight per volume (w/v) of the composition.

The invention is also related to a solid agricultural composition for protecting a plant, plant part, and/or plant seed from cold temperatures, drought conditions, and/or promoting germination comprising:
about 5% to about 15% citric acid and about 85% to about 95% of polyethylene glycol based on the total weight (w/w) of the composition; or
about 80% to about 95% citric acid and about 5% to about 20% of sodium bicarbonate based on the total weight (w/w) of the composition.

Yet another aspect of the invention is to provide an agricultural composition for protecting a plant, plant part, and/or plant seed from cold temperatures, drought conditions, and/or promoting germination, wherein the composition comprises sodium citrate and a fungicide, insecticide, preservative, nematicide, seed fluency agent, biopolymer, or any combination thereof.

The invention is also directed to plant seeds coated with any of the compositions described herein.

It is another aspect of the invention to provide a plant seed coated with an agricultural composition comprising sodium citrate.

In still another aspect, the invention is directed to a method for protecting a plant, plant part, and/or plant seed from cold temperatures, drought conditions, and/or promoting germination and/or extending the life of plant seeds, wherein the method comprises treating or coating plant seeds with any of the compositions disclosed here. In still another aspect, the method comprises treating an area surrounding the plant seeds with any of the compositions of the invention.

It is yet another aspect of the invention to provide a method for protecting a plant, plant part, and/or plant seed from cold temperatures, drought conditions, and/or promoting germination comprising applying a composition to the plant seed or an area surrounding the plant seed, wherein the composition comprises sodium citrate.

Other objects and features will be in part apparent and in part pointed out hereinafter.

### Definitions

The following definitions are provided to better define the invention and to guide those of ordinary skill in the art in the practice of the invention. Unless otherwise noted, terms are to be understood according to conventional usage by those of ordinary skill in the relevant art.

When the articles “a,” “an,” “one,” “the,” and “said” are used herein, they mean “at least one” or “one or more” unless otherwise indicated.

The terms “comprising,” “including,” and “having” are intended to be inclusive and mean that there may be additional elements other than the listed elements.

“Abiotic stress” as used herein is defined as an environmental condition that can have a negative impact on a plant. Abiotic stress can include: temperature (high or low) stress, radiation stress (visible or UV), drought stress, cold stress, salt stress, osmotic stress, nutrient-deficient or high metal stress, or water stress that results in water deficit, flooding or anoxia. Other abiotic stress factors include dehydration, wounding, ozone, and high or low humidity.

Reference in this application to the terms “bioactivity”, “effective”, “efficacious” or variations thereof are terms used interchangeably in this application to describe the effects of compositions in the invention on plant life, growth, yield, and any other measurement of plant success. Such terms describe, for example, an increase in crop production, an increase in above ground biomass, an increase in below ground biomass, an increase in fruit production, and/or sustained health of the plant, as compared to an appropriate control.

The phrases “success”, “productivity”, “yield”, “health”, or variations thereof are intended to include any and/or all ways of measuring plant health, including but not limited to life, survival, yield, productivity, reproductive capacity, above ground or below ground biomass, sprouting frequency, time to fruit or flower, and overall failure-to-thrive.

The phrases “drought conditions” or variations thereof are intended to include any and all situations where an agricultural crop or ornamental plant has reduced exposure to water for any length of time compared to the ideal growing conditions.

The phrases “intolerable cold”, “cold conditions”, “low temperatures,” “cold temperatures” or variations thereof are intended to include any and/or all situations where an agricultural crop or ornamental plant is exposed to temperatures that are below or under the minimum temperature for ideal growing conditions for any length of time.

The phrase “cold germination” or variations thereof are intended to include any and/or all conditions when a plant seed is sowed, planted, or otherwise grown in sub-optimal conditions with regard to the temperature. Specifically, the temperature is below or under the minimum temperature for ideal germination, sprouting, or growth from the seed for any length of time.

The phrase “seed fluency agent” or “dry seed finisher” or variations thereof are intended to include liquid and dry formulations applied to the seed, including talc, graphite, polyethylene-wax powders and polymers, wax esters, wax, mica, starches, soybean and vegetable protein derivatives, and any added pigments, biostimulants, or micronutrient blends. A “dry seed finisher” refers to a powder or dry seed coating applied to a plant seed for one or more of the following purposes: absorbing excess liquid adhering to the plant seed surface after treatment, improving plant seed lubrication, improving plant seed flowability, or improving seed appearance.

A “foliar treatment” as used herein refers to a composition that is applied to the above ground parts or foliage of a plant or plant part and may have leaves, stems, flowers, branches, or any aerial plant part, for example, scion.

A “plant” refers to but is not limited to a monocot plant, a dicot plant, or a gymnosperm plant. The term “plant” as used herein includes whole plants, plant organs, progeny of whole plants or plant organs, embryos, somatic embryos, embryo-like structures, protocorms, protocorm-like bodies, and suspensions of plant cells. Plant organs comprise shoot vegetative organs/structures (e.g., leaves, stems and tubers), roots, flowers and floral organs/structures (e.g., bracts, sepals, petals, stamens, carpels, anthers and ovules), seed including embryo, endosperm, and seed coat and fruit (the mature ovary), plant tissue (e.g., phloem tissue, xylem tissue, vascular tissue, ground tissue, and the like) and cells (e.g., guard cells, egg cells, trichomes and the like).

The term “treating” or “treatment,” or its cognates, as used herein indicates any process or method which prevents, cures, diminishes, reduces, ameliorates, or slows the progression of a disease. Treatment can include reducing pathogen titer in plant tissue or the appearance of disease symptoms relative to controls which have not undergone treatment. Treatment can also be prophylactic (e.g., by preventing or delaying an infection in a plant).

The term “reduction of disease symptoms,” as used herein, refers to a measurable decrease in the number or severity of disease symptoms.

Ratios, concentrations, amounts, and other numerical data may be presented herein in a range format. It is to be understood that such range format is used merely for convenience and brevity and should be interpreted flexibly to include not only the numerical values explicitly recited as the endpoints of the range, but also to include all the individual numerical values or sub-ranges encompassed within that range as if each numerical value and sub-range is explicitly recited. For example, a weight percentage range of 1-5% should be interpreted to include not only the explicitly recited limits of about 1% to about 5%, but also to include sub-ranges, such as 2-4%, 2.5-3.5% and so forth, for example.

The term “seed material” or “seed” or “seedling” relates to seed from a single plant species, a mixture of seed from multiple plant species, or a seed blend from various strains within a plant species intended to be coated for their significance in terms of their seedling vigor, germination percentage, nutrient uptake, and agricultural produce.

The term “seed coating” refers to a layer or layers of non-plant material that either partially or completely cover the outer surfaces of the seeds. “Coated seeds” or “treated seeds” and related terms are used interchangeably through this application.

The term “composition” is used herein to refer to a mixture of two or more chemical substances.

### DETAILED DESCRIPTION OF THE INVENTION

The agricultural compositions of the invention and methods of using them promote germination of plant seeds by protecting the seeds from the effects of water insufficiency, cold temperatures and/or other unfavorable conditions, thereby improving plant health and increasing plant yield. The improved seed germination is observed regardless of whether the compositions are used to treat the seeds directly or whether they are applied to an area surrounding the seeds.

One aspect of the invention to provide an agricultural composition for protecting a plant, plant part, and/or plant seed from cold temperatures, drought conditions, and/or promoting germination wherein the composition comprises:
citric acid having a weight percentage in a range from about 0.2% to about 0.4% based on the total weight per volume (w/v) of the composition; and either one or both of the following:
polyethylene glycol having a weight percentage in a range from about 4.0% to about 5.0% based on the total weight per volume (w/v) of the composition; and/or
sodium bicarbonate having a weight percentage in a range from about 0.01% to about 0.10% based on the total weight per volume (w/v) of the composition.

The agricultural composition can be a liquid, such as a slurry.

The agricultural composition can comprise citric acid and polyethylene glycol.

The agricultural composition can comprise citric acid and sodium bicarbonate.

The agricultural composition can comprise citric acid, polyethylene glycol, and sodium bicarbonate.

Citric acid can be present in the composition in a range from about 0.2% to about 0.4% based on the total weight per volume (w/v) of the composition. In some instances, the range of the citric acid is between about 0.25% and about 0.35% w/v. By way of example and not of limitation, the agricultural composition comprises 0.301%, 0.311% or 0.33% w/v of the citric acid.

When used in the agricultural composition, polyethylene glycol is present in a range from about 4.0% to about 5.0% based on the total weight per volume (w/v) of the composition, or in a range from about 4.2% to about 4.8% w/v. In some instances, the agricultural composition comprises 4.60% or 4.666% polyethylene glycol by w/v.

When used in the agricultural composition, sodium bicarbonate is present in a range from about 0.01% to about 0.10% based on the total weight per volume (w/v) of the composition. In some instances, sodium bicarbonate is present in the range from about 0.02% to about 0.08% w/v. By way of example and not of limitation, the agricultural composition comprises 0.03% w/v of sodium bicarbonate.

The agricultural composition can further comprise a pesticide, a preservative, a seed fluency agent, a biopolymer, or a combination thereof.

When the composition includes a pesticide, the pesticide can comprise an insecticide, a herbicide, a fungicide, a bacteriocide, a nematicide, a miticide, or any combination thereof.

When the composition includes an insecticide, the insecticide can comprise clothianidin, imidacloprid, an organophosphate, a carbamate, a pyrethroid, an acaricide, an alkyl phthalate, boric acid, a borate, a fluoride, sulfur, a haloaromatic substituted urea, a hydrocarbon ester, a biologically-based insecticide, or any combination thereof. For example, the insecticide can comprise clothianidin or imidacloprid.

When the composition includes a herbicide, the herbicide can comprise 2,4-D, 2,4-DB, acetochlor, acifluorfen, alachlor, ametryn, atrazine, aminopyralid, benefin, bensulfuron, bensulfuron methyl bensulide, bentazon, bispyribac sodium, bromacil, bromoxynil, butylate, carfentrazone, chlorimuron, 2-chlorophenoxy acetic acid, chlorsulfuron, chlorimuron ethyl, clethodim, clomazone, clopyralid, cloransulam, CMPP-P-DMA, cycloate, DCPA, desmedipham, dicamba, dichlobenil, diclofop, 2,4-dichlorophenol, dichlorophenoxyacetic acid, dichlorprop, dichlorprop-P, diclosulam, diflufenzopyr, dimethenamid, dimethyl amine salt of 2,4-dichlorophenoxyacetic acid, diquat, diuron, DSMA, endothall, EPTC, ethalfluralin, ethofumesate, fenoxaprop, fluazifop-P, flucarbazone, flufenacet, flumetsulam, flumiclorac, flumioxazin, fluometuron, fluroxypyr, fluorxypyr 1-methyleptylester, fomesafen, fomesafen sodium salt, foramsulfuron, glufosinate, glufosinate-ammonium, glyphosate, halosulfuron, halosulfuron-methyl, hexazinone, 2-hydroxyphenoxy acetic acid, 4-hydroxyphenoxy acetic acid, imazamethabenz, imazamox, imazapic, imazaquin, imazethapyr, isoxaben, isoxaflutole, lactofen, linuron, mazapyr, MCPA, MCPB, mecoprop, mecoprop-P, mesotrione, metolachlor-s, metribuzin, metsulfuron, metsulfuron-methyl, molinate, MSMA, napropamide, naptalam, nicosulfuron, norflurazon, oryzalin, oxadiazon, oxyfluorfen, paraquat, pelargonic acid, pendimethalin, phenmedipham, picloram, primisulfuron, prodiamine, prometryn, pronamide, propanil, prosulfuron, pyrazon, pyrithiobac, pyroxasulfone, quinclorac, quizalofop, rimsulfuron, sethoxydim, siduron, simazine, sulfentrazone, sulfometuron, sulfosulfuron, tebuthiuron, terbacil, thiazopyr, thifensulfuron, thifensulfuron-methyl, thiobencarb, tralkoxydim, triallate, triasulfuron, tribenuron, tribernuron-methyl, triclopyr, trifluralin, triflusulfuron, or any combination thereof.

When the composition includes a nematicide, the nematicide can comprise Bacillusfirmus, fluopyram, antibiotic nematicides such as abamectin; carbamate nematicides such as acetoprole, Bacillus chitonosporus, chloropicrin, benclothiaz, benomyl, Burholderia cepacia, carbofuran, carbosulfan, and cleothocard; dazomet, DBCP, DCIP, alanycarb, aldicarb, aldoxycarb, oxamyl, diamidafos, fenamiphos, fosthietan, phosphamidon, cadusafos, chlorpyrifos, diclofenthion, dimethoate, ethoprophos, fensulfothion, fostiazate, harpins, heterophos, imicyafos, isamidofos, isazofos, methomyl, mecarphon, Myrothecium verrucaria, Paecilomyces lilacinus, Pasteuria nishizawae (including spores thereof), phorate, phosphocarb, terbufos, thionazin, triazophos, tioxazafen, dazomet, 1,2-dicloropropane, 1,3-dichloropropene, furfural, iodomethane, metam, methyl bromide, methyl isothiocyanate, xylenol, or any combination thereof. For example, the nematicide can comprise Bacillus firmus strain i-2580, Pasteuria nishizawae (including spores thereof), or fluopyram.

When the composition includes a bacteriocide, the bacteriocide can comprise streptomycin, penicillins, tetracyclines, oxytetracycline, kasugamycin, ampicillin, oxolinic acid, chlorotetracycline, copper oxide, or any combination thereof. For example, the bacteriocide can comprise oxytetracycline.

The agricultural composition can comprise a fungicide, such as from the stobilurin family or a conazole family of fungicides.

The strobilurin fungicide can comprise a Strobilurin A, a Strobilurin B, a Strobilurin C, a Strobilurin D, a Strobilurin E, a Strobilurin F, a Strobilurin G, a Strobilurin H, an Azoxystrobin, a Trifloxystrobin, a Kresoxim methyl, a Fluoxastrobin, Picoxystrobin, or any combination thereof.

The strobilurin fungicide can comprise a non-naturally occurring strobilurin fungicide such as an Azoxystrobin, a Trifloxystrobin, a Kresoxim methyl, a Fluoxastrobin, or any combination thereof. For example, the strobilurin fungicide comprises a Trifloxystrobin, Fluoxastrobin or Picoxystrobin. Strobilurin fungicides are used to control a range of fungal diseases, including water molds, downy mildews, powdery mildews, leaf spotting and blighting fungi, fruit rotters, and rusts. They are useful for treating a variety of crops, including cereals, field crops, fruits, tree nuts, vegetables, turfgrasses, and ornamentals.

The triazole fungicide can comprise prothioconazole, imidazole, imidazil, prochloraz, propiconazole, triflumizole, diniconazole, flusilazole, penconazole, hexaconazole, cyproconazole, myclobutanil, tebuconazole, difenoconazole, tetraconazole, fenbuconazole, epoxiconazole, metconazole, fluquinconazole, triticonazole, or any combination thereof.

The citric acid in combination with polyethylene glycol and/or sodium bicarbonate can also be formulated with strobilurins and triazole fungicides, especially fluoxastrobin or trifloxystrobin in combination with prothioconazole. For example, the fungicide can comprise azoxystrobin, carboxin, difenoconazole, fludioxonil, fluxapyroxad, ipconazole, mefenoxam, pyraclostrobin, silthiofam, sedaxane, thiram, triticonazole or any combination thereof. As another example, the fungicide can comprise pyraclostrobin, picoxystrobin, metconazole, cyproconazole, fenbuconazole, azoxystrobin, trifloxystrobin, or any combination thereof.

Additional fungicides that can be included in the agricultural composition of the invention comprise aldimorph, ampropylfos, ampropylfos potassium, andoprim, anilazine, azaconazole, azoxystrobin, benalaxyl, benodanil, benomyl, benzamacril, benzamacryl-isobutyl, benzovindflupyr, bialaphos, binapacryl, biphenyl, bitertanol, blasticidin-S, boscalid, bromuconazole, bupirimate, buthiobate, calcium polysulphide, capsimycin, captafol, captan, carbendazim, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, debacarb, dichlorophen, diclobutrazole, diclofluanid, diclomezine, dicloran, diethofencarb, dimethirimol, dimethomorph, dimoxystrobin, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, fludioxonil, flumetover, fluoromide, fluoxastrobin fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, furmecyclox, guazatine, hexachlorobenzene, hexaconazole, hymexazole, imazalil, imibenconazole, iminoctadine, iminoctadine albesilate, iminoctadine triacetate, iodocarb, iprobenfos (IBP), iprodione, irumamycin, isoprothiolane, isovaledione, kasugamycin, kresoxim-methyl, copper preparations, such as: copper hydroxide, copper naphthenate, copper oxychloride, copper sulphate, copper oxide, oxine-copper and Bordeaux mixture, mancopper, mancozeb, maneb, meferimzone, mepanipyrim, mepronil, metconazole, metalzxyl, methasulfocarb, methfuroxam, metiram, metomeclam, metsulfovax, mildiomycin, myclobutanil, myclozolin, nickel dimethyldithiocarbamate, nitrothal-isopropyl, nuarimol, ofurace, oxadixyl, oxamocarb, oxolinic acid, oxycarboxim, oxyfenthiin, paclobutrazole, pefurazoate, penconazole, pencycuron, phosdiphen, picoxystrobin, pimaricin, piperalin, polyoxin, polyoxorim, probenazole, prochloraz, procymidone, propamocarb, propanosine-sodium, propiconazole, propineb, prothiocinazole, pyrazophos, pyrifenox, pyrimethanil, pyroquilon, pyroxyfur, quinconazole, quintozene (PCNB), a strobilurin, sulphur and sulphur preparations, tebuconazole, tecloftalam, tecnazene, tetcyclasis, tetraconazole, thiabendazole, thicyofen, thifluzamide, thiophanate-methyl, tioxymid, tolclofos-methyl, tolylfluanid, triadimefon, triadimenol, triazbutil, a triazole, triazoxide, trichlamide, tricyclazole, triclopyr, tridemorph, trifloxystrobin, triflumizole, triforine, uniconazole, validamycin A, vinclozolin, viniconazole, zarilamide, zineb, ziram and also Dagger G, OK-8705, OK-8801, a-(1,1-dimethylethyl)-(3-(2-phenoxyethyl)-1H-1,2,4-triazole-1-ethanol, a-(2,4-dichlorophenyl)-[3-fluoro-3-propyl-1H-1,2,4-triazole-1-ethanol, a-(2,4-dichlorophenyl)-[3-methoxy-a-methyl-1H-1,2,4-triazole-1-ethanol, a-(5-methyl-1,3-dioxan-5-yl)-[3-[[4-(trifluoromethyl) -phenyl]-met hylene]-1H-1,2,4-triazole-1-ethanol, (5RS,6RS)-6-hydroxy-2,2,7,7-tetramethyl-5-(1H-1,2,4-triazol-1-yl)-3-octanone, (E)-a-(methoxyimino)-N-methyl-2-phenoxy-phenylacetamide, 1-isopropyl{2-methyl-1-[[[1-(4-methylphenyl)-ethyl]-amino]-carbonyl]-propyl}carbamate, 1-(2,4-dichlorophenyl)-2-(1H-1,2,4-triazol-1-yl)-ethanone-O-(phenyl methyl)-oxime, 1-(2-methyl-1-naphthalenyl)-1H-pyrrole-2,5-dione, 1-(3,5-dichlorophenyl)-3-(2-propenyl)-2,5-pyrrolidindione, 1-[(diiodomethyl)-sulphonyl]-4-methyl-benzene, 1-[[2-(2,4-dichlorophenyl)-1,3-dioxolan-2-yl]-methyl]-1H-imidazole, 1-[[2-(4-chlorophenyl)-3-phenyloxiranyl]-methyl]-1H-1,2,4-triazole, 1-[1-[2-[(2,4-dichlorophenyl)-methoxy]-phenyl]-ethenyl]-1H-imidazole, 1-methyl-5-nonyl-2-(phenylmethyl)-3-pyrrolidinole, 2′,6′-dibromo-2-methyl-4′-trifluoromethoxy-4′-trifluoro-methyl-1,3-thiazole-carboxanilide, 2,2-dichloro-N-[1-(4-chlorophenyl)-ethyl]-1-ethyl-3-methyl-cyclopropanecarboxamide, 2,6-dichloro-5-(methylthio)-4-pyrimidinyl-thiocyanate, 2,6-dichloro-N-(4-trifluoromethylbenzyl)-benzamide, 2,6-dichloro-N-[[4-(trifluoromethyl)-phenyl]-methyl]-benzamide, 2-(2,3,3-triiodo-2-propenyl)-2H-tetrazole, 2-[(1-methylethyl)-sulphonyl]-5-(trichloromethyl)-1,3,4-thiadiazole, 2-[[6-deoxy-4-O-(4-O-methyl-(3-D-glycopyranosyl)-a-D-glucopyranos yl]-amino]-4-methoxy-1H-pyrrolo[2,3-d]pyrimidine-5-carbonitrile, 2-aminobutane, 2-bromo-2-(bromomethyl)-pentanedinitrile, 2-chloro-N-(2,3-dihydro-1,1,3-trimethyl-1H-inden-4-yl)-3-pyridinecarboxamide, 2-chloro-N-(2,6-dimethylphenyl)-N-(isothiocyanatomethyl)-acetamide, 2-phenylphenol (OPP), 3,4-dichloro-1-[4-(difluoromethoxy)-phenyl]-pyrrole-2,5-dione, 3,5-dichloro-N-[cyano[(1-methyl-2-propynyl)-oxy]-methyl]-benzamide, 3-(1,1-dimethylpropyl-1-oxo-1H-indene-2-carbonitrile, 3-[2-(4-chlorophenyl)-5-ethoxy-3-isoxazolidinyl]-pyridine, 4-chloro-2-cyano-N,N-dimethyl-5-(4-methylphenyl)-1H-imidazole-1-sulphonamide, 4-methyl-tetrazolo[1,5-a]quinazolin-5(4H)-one, 8-(1,1-dimethylethyl)-N-ethyl-N-propyl-1,4-dioxaspiro[4,5]decane-2-methanamine, 8-hydroxyquinoline sulphate, 9H-xanthene-2-[(phenylamino)-carbonyl]-9-carboxylic hydrazide, bis-(1-methylethyl)-3-methyl-4-[(3-methylbenzoyl)-oxy]-2,5-thiophenedicarboxylate, cis-1-(4-chlorophenyl)-2-(1H-1,2,4-triazol-1-yl)-cycloheptanol, cis-4-[3-[4-(1,1-dimethylpropyl)-phenyl-2-methylpropyl]-2,6-dimethyl-morpholine hydrochloride, ethyl [(4-chlorophenyl)-azo]-cyanoacetate, potassium bicarbonate, methanetetrathiol-sodium salt, methyl 1-(2,3-dihydro-2,2-dimethyl-inden-1-yl)-1H-imidazole-5-carboxylate, methyl N-(2,6-dimethylphenyl)-N-(5-isoxazolylcarbonyl)-DL-alaninate, methyl N-(chloroacetyl)-N-(2,6-dimethylphenyl)-DL-alaninate, N-(2,3-dichloro-4-hydroxyphenyl)-1-methyl-cyclohexanecarboxamide, N-(2,6-dimethyl phenyl)-2-methoxy-N-(tetra hydro-2-oxo-3-furanyl)-acetamide, N-(2,6-dimethyl phenyl)-2-methoxy-N-(tetrahydro-2-oxo-3-thienyl)-acetamide, N-(2-chloro-4-nitrophenyl)-4-methyl-3-nitro-benzenesulphonamide, N-(4-cyclohexylphenyl)-1,4,5,6-tetrahydro-2-pyrimidinamine, N-(4-hexylphenyl)-1,4,5,6-tetrahydro-2-pyrimidinamine, N-(5-chloro-2-methylphenyl)-2-methoxy-N-(2-oxo-3-oxazolidinyl)-acetamide, N-(6-methoxy)-3-pyridinyl)-cyclopropanecarboxamide, N-[2,2,2-trichloro-1-[(chloroacetyl)-amino]-ethyl]-benzamide, N-[3-chloro-4,5-bis(2-propinyloxy)-phenyl]-N′-methoxy-methanimidamide, N-formyl-N-hydroxy-DL-alanine-sodium salt, 0,0-diethyl [2-(dipropylamino)-2-oxoethyl]-ethylphosphoramidothioate, O-methyl S-phenyl phenylpropylphosphoramidothioate, S-methyl 1,2,3-benzothiadiazole-7-carbothioate, and spiro[2H]-1-benzopyrane-2,1′(3′H)-isobenzofuran]-3′-one, N-trichloromethyl)thio-4-cyclohexane-1,2-dicarboximide, tetramethylthioperoxydicarbonic diamide, methyl N-(2,6-dimethylphenyl)-N-(methoxyacetyl)-DL-alaninate, 4-(2,2-difluoro-1,3-benzodioxol-4-yl)-1-H-pyrrol-3-carbonitril, or any combination thereof.

Seed fluency agents are well known in the art and can optionally be included in the agricultural compositions. Seed fluency agents such as talc, graphite, polyethylene-wax powders and polymers, wax esters, wax, mica, starches, and soybean and vegetable protein derivatives are readily available for formulation.

When the composition includes a preservative, the preservative is usually present at less than 2% v/v, less than 1% v/v, or less than 0.5% v/v of the total composition. The preservative can comprise those based on dichlorophene and benzylalcohol hemi formal (PROXEL from ICI or ACTICIDE RS from Thor Chemie and KATHON MK from Dow Chemical) and isothiazolinone derivatives such as alkylisothiazolinones and benzisothiazolinones (ACTICIDE MBS from Thor Chemie). As further examples, suitable preservatives include Proxel BD (1,2-Benzisothiazol-3-one), MIT (2-methyl-4-isothiazolin-3-one), BIT (1,2-benzisothiazolin-3-one, which can be obtained from Avecia, Inc. as PROXEL GXL as a solution in sodium hydroxide and dipropylene glycol), 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one, benzyl alcohol hemiformal, or any combination thereof.

For example, the preservative can be Proxel BD (1,2-Benzisothiazol-3-one), which can be present at less than 0.6 v/v, such as at about 0.5% or about 0.4% v/v of the total composition.

The agricultural compositions of the invention can include a biopolymer. The biopolymer can include but is not limited to a polyester, polyether ester, polyanhydride, polyester urethane, polyester amide, polyvinyl acetate, polyvinyl acetate copolymer, polyvinyl alcohol, tylose, polyvinyl alcohol copolymer, polyvinylpyrrolidone, polysaccharide including starch, modified starch and starch derivative, dextrin, maltodextrin, alginate, chitosan and cellulose, cellulose ester, cellulose ether and cellulose ether ester including ethylcellulose, methylcellulose, hydroxymethylcellulose, hydroxypropylcellulose and carboxymethylcellulose, fat, oil, protein including casein, gelatin and zein; gum arabic, shellac, vinylidene chloride, and vinylidene chloride copolymer, lignosulfonate (e.g., calcium lignosulfonate), polyacrylate, polymethacrylate and acrylic copolymer, polyvinylacrylate, polyethylene oxide, polybutene, polyisobutene, polystyrene, polybutadiene, polyethyleneamine, polyethylenamide, acrylamide polymer and copolymer, polyhydroxyethyl acrylate, methylacrylamide monomer, polychloroprene, or any combination thereof.

A number of non-limiting examples of the compositions of the invention are listed below: citric acid and polyethylene glycol; citric acid and sodium bicarbonate; citric acid, polyethylene glycol, and sodium bicarbonate; citric acid, polyethylene glycol, and talc; citric acid, polyethylene glycol, talc, and graphite; citric acid, sodium bicarbonate and talc; citric acid, sodium bicarbonate, talc, and graphite; citric acid, polyethylene glycol, and 1,2-Benzisothiazol-3-one; or citric acid, sodium bicarbonate, and 1,2-Benzisothiazol-3-one.

The invention also relates to a solid agricultural composition for protecting a plant, plant part, and/or plant seed from cold temperatures, drought conditions, and/or promoting germination comprising about 5% to about 15% of citric acid and about 85% to about 95% of polyethylene glycol based on the total weight (w/w) of the composition; or about 80% to about 95% of citric acid and about 5% to about 20% of sodium bicarbonate based on the total weight (w/w) of the composition. The solid composition with citric acid and polyethylene glycol is diluted in a seed fluency agent, for example at a rate from about 10-fold to about 15,000-fold, from about 15-fold to about 10,000-fold, from about 50-fold to about 8,000, or from about 100-fold to about 5,000-fold, or from about 250-fold to about 3,500-fold before application to seeds.

The solid composition with citric acid and sodium bicarbonate is diluted in a seed fluency agent, for example at a rate from about 100-fold to about 150,000-fold, from about 250-fold to about 125,000-fold, from about 500-fold to about 100,000-fold, or from about 1,000-fold to about 60,000-fold, or from about 3,800-fold to about 53,000-fold for seed treatment. Talc and/or graphite are two exemplary seed fluency agents applicable for the solid compositions of the invention.

In some instances, the solid compositions are in the form of powder.

Table 1 shows the dilutions and ranges of compositions with citric acid and polyethylene glycol in liquid (e.g. a slurry) formulation and solid (e.g., a powder) formulation, and Table 2 shows the same parameters for compositions with citric acid and sodium bicarbonate.

TABLE 1

| | | | Percentage of | | | Final ingredient | |
|---|---|---|---|---|---|---|---|
| | | | Ingredient in | | | concentration in | |
| | | | concentrated | | | Diluted application/ | |
| Formulation | Application | Ingredient | form | Fold dilution | | finished form (%) | |
| Citric acid | Seed | citric acid | 0.33% | low | 406.5 | low | 0.0008118% |
| and | Treatment | | | high | 12.68 | high | 0.02602% |
| polyethylene | Slurry | PEG | 4.60% | low | 406.5 | low | 0.01132% |
| glycol (PEG) | (liquid) | | | high | 12.68 | high | 0.3627% |
| | Seed | citric acid | 6.69% | low | 8233 | low | 0.0008125% |
| | Powder | | | high | 11.7 | high | 0.5718% |
| | (solid) | PEG | 93.31% | low | 8233 | low | 0.01133% |
| | | | | high | 11.7 | high | 7.975% |

TABLE 2

| | | | Percentage of | | | Final ingredient | |
|---|---|---|---|---|---|---|---|
| | | | Ingredient in | | | concentration in Diluted | |
| | | | concentrated | | | application/ finished | |
| Formulation | Application | Ingredient | form | Fold dilution | | form (%) | |
| Citric acid | Seed | citric acid | 0.30% | low | 405.8 | low | 0.0007392% |
| and sodium | Treatment | | | high | 12.68 | high | 0.02366% |
| bicarbonate | Slurry | sodium | 0.03% | low | 405.8 | low | 0.00007392% |
| | (liquid) | bicarbonate | | high | 12.68 | high | 0.002366% |
| | Seed | citric acid | 90.91% | low | 123,077 | low | 0.0007386% |
| | Powder | | | high | 3590 | high | 0.02532% |
| | (solid) | sodium | 9.09% | low | 123,077 | low | 0.00007386% |
| | | bicarbonate | | high | 3590 | high | 0.002532% |

Alternatively, Table 3 shows the same dilution parameters for citric acid and polyethylene glycol and citric acid and sodium bicarbonate expressed in terms of percentages instead of fold dilution.

TABLE 3
Citric Acid and Polyethylene Glycol Formulation

| | | | Percentage of | |
|---|---|---|---|---|
| | | Percentage of | Concentrate in | Final ingredient |
| | | Ingredient in | Diluted | concentration in |
| | | Concentrate | application/ | Diluted application/ |
| Application | Ingredient | form | finished form | finished form (%) |
| Seed Treatment | Citric Acid | 0.33000% | 0.246% | 0.0008118% |
| Slurry (liquid) | | | 7.886% | 0.02602% |
| | PEG | 4.60000% | 0.246% | 0.01132% |
| | | | 7.886% | 0.3627% |
| Seed Powder | Citric Acid | 6.69000% | 0.012% | 0.0008125% |
| (solid) | | | 8.547% | 0.5718% |
| | PEG | 93.31000% | 0.012% | 0.01133% |
| | | | 8.457% | 7.975% |

Citric Acid and Sodium Bicarbonate Formulation

| | | | Percentage of | |
|---|---|---|---|---|
| | | Percentage of | Concentrate in | Final ingredient |
| | | Ingredient in | Diluted | concentration in |
| | | Concentrated | application/ | Diluted application/ |
| Application | Ingredient | formulation | finished form | finished form (%) |
| Seed Treatment | Citric Acid | 0.30000% | 0.246% | 0.0007392% |
| Slurry (liquid) | | | 7.886% | 0.02366% |
| | Sodium | 0.03000% | 0.246% | 0.00007392% |
| | Bicarbonate | | 7.886% | 0.002366% |
| Seed Powder | Citric Acid | 90.91000% | 0.000815% | 0.0007386% |
| (solid) | | | 0.028% | 0.02532% |
| | Sodium | 9.09000% | 0.000815% | 0.00007386% |
| | Bicarbonate | | 0.028% | 0.002532% |

Another aspect of the invention is directed to an agricultural composition for protecting a plant, plant part, and/or plant seed from cold temperatures, drought conditions, and/or promoting germination, wherein the composition comprises sodium citrate and a fungicide, insecticide, preservative, nematicide, seed fluency agent, biopolymer, or any combination thereof.

The composition typically comprises sodium citrate having a weight percentage in a range from about 0.200 to about 1.500 based on the total weight per volume (w/v) of the composition. In some instances, sodium citrate is present in a range from about 0.27% to about 1.45%. Any of the fungicide, insecticide, preservative, nematicide, seed fluency agent, biopolymer, or any combination thereof as described herein can be combined in the composition with sodium citrate.

The active components of the agricultural compositions disclosed herein are typically formulated with a carrier, such as water, a buffer such as, but not limited to, citrate or phosphate buffer, or other treating agents such as, but not limited to, alcohol or another solvent, and/or any water soluble agent.

In addition, small amounts of drying agent enhancers, such as, but not limited to, lower alcohols, can be used in seed coating mixtures.

Surfactants and emulsifiers can also be added to the agricultural composition at relatively low levels to enhance the stability of the seed coating product.

The carrier for the agricultural compositions of the invention can be water.

The agricultural compositions can be in the form of an aqueous solution, a slurry or dispersion, an emulsion, a powder formulation or any other desirable form for applying the composition to plant seeds.

It is another aspect of the invention to provide plant seeds that have been treated with any of the agricultural compositions disclosed herein. The agricultural compositions can be applied as seed coatings or dressings.

The seed coatings can be applied using conventional methods known in the art, for example by seed dressing, film coating or pelleting. Similarly, seed treatments can be done by soaking or spraying the seeds. The seeds can be treated with liquid compositions, for example by soaking or spraying the seeds or by applying the compositions in the form of a powder coating.

The seeds can be treated by both methods, i.e., first by applying the liquid compositions of the invention followed by the treatment with the solid compositions.

The compositions of the invention can be applied directly to the plant seed or in combination with other commercially available additives, such as coloring agents.

Plant seeds can be treated using a variety of methods including but not limited to pouring, pumping, drizzling, or spraying an aqueous solution on or over a seed; or spraying or applying the composition onto a layer of plant seeds either with or without the use of a conveyor system. Mixing devices useful for seed treatment include but are not limited to tumblers, mixing basins, mixing drums, and fluid application devices that include basins or drums used to contain the plant seed while coating.

Seed treatment can also include the method of seed priming. Seed priming includes treating the seed prior to sowing where the seeds are soaking in a solution that results in partial hydration but not yet germination, allowing for metabolic processes to begin, preparing the seed for germination. The types of seed priming include but are not limited to hydropriming, osmopriming, or halopriming with the compositions described herein.

After seed treatment, the plant seed can be air-dried, or a stream of dry air can be optionally used to aid in the drying of the seed coatings. Seed treatments can be applied using any commercially available seed treatment machinery or can also be applied using any acceptable non-commercial method or methods such as the use of syringes or any other seed treatment device. Following the treatment or coating of plant seeds, they are sowed using any of the conventional methods known in the art.

Any of the compositions of the invention can also be used to treat plant transplants or plant propagules. By way of example and not of limitation, a propagule or transplant can be sprayed, soaked or powder coated with a composition of the invention.

Another aspect of the invention provides a method for protecting a plant, plant part, and/or plant seed from cold temperatures, drought conditions, and/or promoting germination wherein the method comprises treating or coating plant seeds with any of the compositions described here. Options for treating or coating the seeds are described above. For purposes of this method, plant seeds are treated or coated prior to sowing.

In another aspect, the method comprises applying a composition of the invention to an area surrounding the plant seeds. This is typically done once the plant seeds have been sowed. Alternatively, it can be done prior to sowing the plant seeds.

Yet another aspect of the invention is a method for protecting a plant, plant part, and/or plant seed from cold temperatures, drought conditions, and/or promoting germination comprising applying a composition to the plant seed or an area surrounding the plant seed, wherein the composition comprises sodium citrate. Furthermore, the composition comprising sodium citrate can include a pesticide, a preservative, a seed fluency agent, a biopolymer, or a combination thereof, as discussed herein.

The benefits of the methods of the invention for the plant seeds that have been treated include but are not limited to:
A) increased growth of the plants; and/or
B) increased germination rates; and/or
C) increased nutrient uptake by the plants; and/or
D) increased root nodulation of the plants;
E) increased crop yield; and/or
F) decreased susceptibility to an environmental stress, including but not limited to drought, flood, hot temperatures, cold temperatures, freezing, salt, heavy metals, low pH, high pH, or a combination of any thereof, when compared to plants grown out of seeds under the same conditions but not treated/coated with a composition of the invention.

Plants grown out of seeds treated with a composition of the invention can exhibit increases in yield or total plant weight by at least about 0.5%, or by at least about 1%, or by at least about 2%, or by at least about 3%, or by at least about 4%, or by at least about 5%, or by at least about 6%, or by at least about 7%, or by at least about 8%, or by at least about 9%, or by at least about 10%, or by at least about 11%, or by at least about 12%, or by at least 15%, or by at least 20%, or by at least 25% when compared to plants grown out of seeds under the same conditions but without treatment. For example, the increase can be between 1%-10%, 1%-20%, 1%-30%, 10%-20%, 10%-30%, 15%-35%, 15-40%, 20%-50%, 30%-60%, and 30%-75%.

The composition of the invention can improve some aspect of plant vigor, such as, but not limited to, plant success measurements like germination, by at least about 0.5%, or by at least about 1%, or by at least about 2%, or by at least about 3%, or by at least about 4%, or by at least about 5%, or by at least about 6%, or by at least about 7%, or by at least about 8%, or by at least about 9%, or by at least about 10%, or by at least about 11%, or by at least about 12%, or by at least 15%, or by at least 20%, or by at least 25% when compared to plants grown out of seeds under the same conditions but without treatment. For example, the germination can increase between 1%-10%, 1%-20%, 1%-30%, 10%-20%, 10%-30%, 15%-35%, 15-40%, 20%-50%, 30%-60%, or 30%-75%.

In any of the methods herein, plants grown out of seeds in the presence of any of the disclosed compositions can exhibit altered leaf senescence as compared to plants grown out of seeds under the same conditions but without the treatment.

In the methods which use compositions comprising citric acid and one or both of polyethylene glycol and sodium bicarbonate, the amounts of these components can include the minimum amount of each of the citric acid, polyethylene glycol, and/or sodium bicarbonate in either the liquid or solid form up to the sum of the maximum liquid and solid amounts for each of these components when the seeds are treated with both the liquid and solid formulations of the invention. The amounts are typically expressed in grams per seed unit. A “seed unit” is a well-known measure in the agricultural arts. It refers to a distinct seed count, which varies among different plants. By way of example and not of limitation, one seed unit of corn measures 80,000 seeds and one seed unit of soybean measures 140,000 seeds. Table 4 with representative numbers of seeds for seed units of different plants is shown below. As is known in the art, for each plant, a seed unit weighs about 50 pounds.

TABLE 4

| Seed Type | Seeds per pound (lb) | Seeds per Unit Seed |
|---|---|---|
| Bermudagrass - Hulled | 2,100,000 | 105,000,000 |
| Bermudagrass - Unhulled | 1,400,000 | 70,000,000 |
| Bermudagrass - Hulled & | 1,050,000 | 52,500,000 |
| Coated | | |
| Lettuce | 400,000 | 20,000,000 |
| Switchgrass | 259,000 | 12,950,000 |
| Grass - Unhulled | 1,500,000 | 75,000,000 |
| Tomatoes | 120,000 | 6,000,000 |
| Carrots | 294,900 | 14,745,000 |
| Parsley | 296,500 | 14,825,000 |
| Mustard | 240,000 | 12,000,000 |
| Basil | 320,000 | 16,000,000 |
| Cilantro | 32,000 | 1,600,000 |
| Cucumbers | 15,200 | 760,000 |
| Peppers | 80,000 | 4,000,000 |
| Squash | 4,000 | 200,000 |
| Canola (Brassicas) | 115,000 | 5,750,000 |
| Sugar Beets | 10,000 | 500,000 |
| Sunflower | 6,400 | 320,000 |
| Spinach | 33,600 | 1,680,000 |
| Lentils | 14,800 | 740,000 |
| Rice | 20,734 | 1,036,700 |
| Wheat | 13,500 | 675,000 |
| Cotton | 5,000 | 250,000 |
| Soy | 2,800 | 140,000 |
| Corn | 1,600 | 80,000 |

The liquid compositions of the invention can be diluted about 10-fold to about 50,000-fold, or about 10-fold to about 5,000-fold, or about 10-fold to 2,500-fold, or about 10-fold to about 1,000-fold, or about 10-fold to about 500-fold, or about 12-fold to about 406-fold. The solid compositions of the invention can be diluted in a seed fluency agent at different rates, depending on the components. Solid compositions with citric acid and PEG are diluted a rate from about 10-fold to about 15,000-fold, from about 15-fold to about 10,000-fold, from about 50-fold to about 8,000-fold, or from about 100-fold to about 5,000-fold, or from about 250-fold to about 3,500-fold, whereas solid compositions with citric acid and sodium bicarbonate are diluted in a seed fluency agent at a rate from about 100-fold to about 150,000-fold, from about 250-fold to about 125,000-fold, from about 500-fold to about 100,000-fold, or from about 1,000-fold to about 60,000-fold, or from about 3,800-fold to about 53,000-fold.

Plant seeds can come from any plants, such as a dicotyledon, a monocotyledon, a gymnosperm, or an angiosperm. Accordingly, a plant seed is a seed of a dicotyledon, a monocotyledon, a gymnosperm, or an angiosperm.

For example, where the plant is a dicotyledon or the seed is a seed of a dicotyledon, the dicotyledon can comprise bean, pea, tomato, pepper, squash, alfalfa, almond, anise seed, apple, apricot, arracha, artichoke, avocado, bambara, groundnut, beet, bergamot, black pepper, black wattle, blackberry, blueberry, bitter orange, bok-choi, Brazil nut, breadfruit, broccoli, broad bean, Brussels sprouts, buckwheat, cabbage, camelina, Chinese cabbage, cacao, cantaloupe, caraway seeds, cardoon, carob, carrot, cashew nuts, cassava, castor bean, cauliflower, celeriac, celery, cherry, chestnut, chickpea, chicory, chili pepper, chrysanthemum, cinnamon, citron, citrus, clementine, clove, clover, coffee, cola nut, colza, corn, cotton, cottonseed, cowpea, crambe, cranberry, cress, cucumber, currant, custard apple, drumstick tree, earth pea, echium, eggplant, endive, fennel, fenugreek, fig, filbert, flax, geranium, gooseberry, gourd, grape, grapefruit, guava, hemp, hempseed, henna, hop, horse bean, horseradish, indigo, jasmine, Jerusalem artichoke, jute, kale, kapok, kenaf, kiwi, kohlrabi, kumquat, lavender, lemon, lentil, lespedeza, lettuce, lime, liquorice, litchi, loquat, lupine, macadamia nut, mace, mandarin, mangel, mango, medlar, melon, mint, mulberry, mustard, nectarine, niger seed, nutmeg, okra, olive, opium, orange, papaya, parsnip, pea, peach, peanut, pear, pecan nut, persimmon, pigeon pea, pistachio nut, plantain, plum, pomegranate, pomelo, poppy seed, potato, sweet potato, prune, pumpkin, quebracho, quince, trees of the genus Cinchona, quinoa, radish, ramie, rapeseed, raspberry, rhea, rhubarb, rose, rubber, rutabaga, safflower, sainfoin, salsify, sapodilla, satsuma, scorzonera, sesame, shea tree, soybean, spinach, squash, strawberry, sugar beet, sugarcane, sunflower, swede, sweet pepper, tangerine, tea, teff, tobacco, tomato, trefoil, tung tree, turnip, urena, vetch, walnut, watermelon, yerba mate, wintercress, shepherd's purse, garden cress, peppercress, watercress, pennycress, star anise, laurel, bay laurel, cassia, jamun, dill, tamarind, peppermint, oregano, rosemary, sage, soursop, pennywort, calophyllum, balsam pear, kukui nut, Tahitian chestnut, basil, huckleberry, hibiscus, passionfruit, star apple, sassafras, cactus, St. John's wort, loosestrife, hawthorn, cilantro, curry, plant, kiwi, thyme, zucchini, ulluco, jicama, waterleaf, spiny monkey orange, yellow mombin, starfruit, amaranth, wasabi, Japanese pepper, yellow plum, mashua, Chinese toon, New Zealand spinach, bower spinach, ugu, tansy chickweed, jocote, Malay apple, paracress, sowthistle, Chinese potato, horse parsley, hedge mustard, campion, agate, cassod tree, thistle, burnet, star gooseberry, saltwort, glasswort, sorrel, silver lace fern, collard greens, primrose, cowslip, purslane, knotgrass, terebinth, tree lettuce, wild betel, West African pepper, yerba santa, tarragon, parsley, chervil, land cress, burnet saxifrage, honeyherb, butterbur, shiso, water pepper, perilla, bitter bean, oca, kampong, Chinese celery, lemon basil, Thai basil, water mimosa, cicely, cabbage-tree, moringa, mauka, ostrich fern, rice paddy herb, yellow saway lettuce, lovage, pepper grass, maca, bottle gourd, hyacinth bean, water spinach, catsear, fishwort, Okinawan spinach, lotus sweetjuice, gallant soldier, culantro, arugula, cardoon, caigua, mitusba, chipilin, samphire, mampat, ebolo, ivy gourd, cabbage thistle, sea kale, chaya, huauzontle, Ethiopian mustard, magenta spreen, good king henry, epazole, lamb's quarters, centella plumed cockscomb, caper, rapini, napa cabbage, mizuna, Chinese savoy, kai-lan, mustard greens, Malabar spinach, chard, marshmallow, climbing wattle, China jute, paprika, annatto seed, spearmint, savory, marjoram, cumin, chamomile, lemon balm, allspice, bilberry, cherimoya, cloudberry, damson, pitaya, durian, elderberry, feijoa, jackfruit, jambul, jujube, physalis, purple mangosteen, rambutan, redcurrant, blackcurrant, salal berry, satsuma, ugli fruit, azuki bean, black bean, black-eyed pea, borlotti bean, common bean, green bean, kidney bean, lima bean, mung bean, navy bean, pinto bean, runner bean, mangetout, snap pea, sweet pea, broccoflower, calabrese, nettle, bell pepper, raddichio, daikon, white radish, skirret, tat soi, broccolini, black radish, burdock root, fava bean, broccoli raab, lablab, lupin, sterculia, velvet beans, winged beans, yarn beans, mulga, ironweed, umbrella bush, tjuntjula, wakalpulka, witchetty bush, wiry wattle, chia, beech nut, candlenut, colocynth, mamoncillo, Maya nut, mongongo, ogbono nut, paradise nut, cempedak, a nursery plant, or an ornamental plant. Nursery plants include but are not limited to rose, marigold, primrose, dogwood, pansy, geranium, etc.

Where the plant is a monocotyledon or the seed is a seed of a monocotyledon, the monocotyledon can comprise corn, wheat, oat, rice, barley, millet, banana, onion, garlic, asparagus, ryegrass, fonio, raishan, nipa grass, turmeric, saffron, galangal, chive, cardamom, date palm, pineapple, shallot, leek, scallion, water chestnut, ramp, Job's tears, bamboo, ragi, spotless watermeal, arrowleaf elephant ear, Tahitian spinach, abaca, areca, bajra, betel nut, broom millet, broom sorghum, citronella, coconut, cocoyam, maize, dasheen, durra, durum, wheat, edo, fique, formio, ginger, orchard grass, esparto grass, Sudan grass, guinea corn, Manila hemp, henequen, hybrid maize, jowar, lemon grass, maguey, bulrush millet, finger millet, foxtail millet, Japanese millet, proso millet, New Zealand flax, oil palm, palm palmyra, sago palm, redtop, sisal, sorghum, spelt wheat, sweet corn, sweet sorghum, sugarcane, taro, teff, timothy grass, triticale, vanilla, yarn, a nursery plant, or an ornamental plant.

Where the plant is a gymnosperm or the seed is a seed of a gymnosperm, the gymnosperm can be from a family comprising Araucariaceae, Boweniaceae, Brassicaceae, Cephalotaxaceae, Cupressaceae, Cycadaceae, Ephedraceae, Ginkgoaceae, Gnetaceae, Pinaceae, Podocarpaceae, Taxaceae, Taxodiaceae, Welwitschiaceae, and Zamiaceae.

Where the plant is an ornamental plant, the ornamental plant can be from a family comprising azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), chrysanthemum and marigold (Calendula officinalis).

Where the plant is an herb or spice plant, the herb or spice plant can be from a family comprising antihelmintic herbs such as Basil (Ocimum basilicum), Chamomile (Marticaria recutita, Chamaemelum nobile), Juniper (Juniperus communis), Artemisia (Artemisia absinthium, Artemisia absinthe); anti-inflammatory herbs such as Acerola (Malpighia Emarginata), Achiote/annatto, Agrimony (Agrimonia), Aloe Vera (Aloe Barbadensis), Arnica (Arnica montana), Beetroot (Beta vulgaris L), Bergamot Orange (Citrus bergamia), Black Cohosh (Cimicifuga racemosa), Borage/starflower (Borago officinalis), Cats Claw (Uncaria tomentosa), Cayenne (Capsicum annuum), Cissus (Cissus quadrangularis), Coriander (Coriandrum sativum), Devil's Claw (Harpagophytum procumbens), Purple Coneflower (Echinacea purpurea), Elder plant (Sambucus), Eyebright (Euphrasia rostkoviana, Euphrasia officinalis), Evening Primrose Oil (Oenothera biennis), Feverfew (Tanacetum parthenium), Flaxseed (Linum usitatissimum), Fo Ti Root (Fallopia multiflora), Ganoderma (Ganoderma lucidum), Geranium (Geranium maculatum), Ginger Root (Zingiber officinale), Ginkgo (Ginkgo biloba), Ginseng (Panax ginseng), Gotu Kola (Centella asiatica), Hemp (Cannabis), Horse Chestnut (Aesculus hippocastanum), Horsetail (Equisetum), Lemon Balm/melissa (Melissa officinalis), Licorice Root (Glycyrrhiza glabra), Marjoram (Origanum majorana), Marshmallow (Althaea), Milk Thistle (Silybum marianum), Mint (Mentha spicata), Nettle (Urtica dioica), Nutmeg (Myristica fragrans), Peppermint (Mentha×Piperita, Mentha balsamea), Prickly Pear Cactus (Opuntia ficus-indica), Rosemary (Rosmarinus officinalis), Sage (Salvia officinalis), Sarsaparilla (Smilax ornata), Siberian Ginseng (Eleutherococcus senticosus), Thyme (Thymus vulgaris), Turmeric (Curcuma longa), Cumin (Cuminum cyminum), Cardamon (Elettaria, Amomum, Zingiberaceae) Yarrow (Achillea millefolium); Lavender (Lavendula angustifolia), Bay laurel (Laurus nobilis), Caraway (Carum carvi) also known as meridian fennel or Persian cumin), Catnip (Nepeta cataria), Chervil (Anthriscus cerefolium), Chives (Allium schoenoprasum), Mexican coriander (Eryngium foetidum), Chinese parsley (Heliotropium curassavicum), and Cilantro (Coriandrum sativum), Garlic (Allium sativum), Kelp (Phaeophyceae), Black Pepper (Piper nigrum), Peppermint (Mentha×piperita), Saffron (Crocus sativus), Rose hip (Rosa), Spearmint (Mentha spicata), St. John's Wort (Hypericum perforatum), Tarragon (Artemisia dracunculus), Wasabi (Eutrema japonicum), Allspice (Pimpinella anisum), Cayenne (Cassicum annuum), Paprika (Capsicum annuum), Cinnamon (Cinnamomum zeylaticum), Cloves (Syzgium aromaticum), Dill (Anethum graveolens), Fennel (Foeniculum vulgare), Fenugreek (Trigonella foenum-graecum), Flaxseed (Linum usitatissimum), Green Tea (Camellia sinensis), Mace (Myristica fragrans), Mustard (Brassica, Sinapsis), Vanilla (Vanilla planifolia, Vanilla pompona) and other medicinal or nutraceutical plants, such as Jojoba (Simmondsia chinensis, Simmondsia californica), Aloe vera (Aloe vera, (L)), and Cannabis (Cannabis sativa).

The plant seeds can be seeds of core crops, vegetables, fruits, trees, fiber crops, oil crops, tuber crops, coffee, flowers, legumes, and cereals. More specifically, the plant seeds can be seeds of peanut, tobacco, cotton, soybean, corn, grasses, wheat, barley, rye, sorghum, rice, rapeseed, sugar beet, sunflower, tomato, pepper, bean, lettuce, potato, carrot, apples, pears, citrus fruits, and grapes.

The plants and plant seeds described herein include transgenic plants or plant seeds such as 1) transgenic cereals, as exemplified by but not limited to wheat and rice, maize, soybean, potato, cotton, tobacco, oilseed rape, 2) fruit plants, such as but not limited to fruit of apples, pears, citrus fruits, and grapes, including wine grapes, or 3) vegetable plants, including but not limited to potato, sugar beet, lettuce, pepper, tomato, and carrot. For example, transgenic plants and seeds can include corn, soybeans, potatoes, cotton, tobacco, sugar beet, sugarcane, and oilseed rape.

The genetically modified plants and seeds can express herbicide tolerance, or tolerance to environmental factors such as but not limited to water stress, drought, viruses, and nitrogen production, or resistance to bacterial, fungi, or insect toxins.

Particularly useful transgenic plants and plant seeds which may be treated according to the invention are plants containing transformation events, or a combination of transformation events, that are listed for example in the databases from various nation or regional regulatory agencies.

Having described the invention in detail, it will be apparent that modification and variations are possible without departing from the scope of the invention defined in the appended claims.

### EXAMPLES

### Example 1: The Effects of Compositions of Citric Acid and Polyethylene Glycol and of Citric Acid and Sodium Bicarbonate on Germination Rates of Corn Under Cold Conditions

The liquid concentrate slurries in the examples were made with 0.33% citric acid and 4.60% polyethylene glycol in a base seed treatment, or with 0.30% citric acid and 0.03% sodium bicarbonate in the base seed treatment. The “base seed treatment” is used herein interchangeably with the “base, “base mixture,” or “base treatment,” and refers to a commercially standard composition for formulating agricultural compositions. When liquid, the base contains water, and typically on one or more of the following: a pesticide, a preservative, a seed fluency agent, a biopolymer, a biostimulant, a micronutrient blend, a microbial inoculant, a colorant, or a diluent. When solid, the base mixture typically contains talc and/or graphite, and may contain one or more of the following: a pesticide, a preservative, a seed fluency agent, a biopolymer, a biostimulant, a micronutrient blend, a microbial inoculant, a colorant, or a diluent.

297 corn seeds per treatment were treated with a liquid treatment of 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under cold conditions at 10° C. Percent germination was calculated by the number of seeds germinated divided by the total number of seeds sowed. It was observed that citric acid and polyethylene glycol increased germination rate of corn, shown in Table 5.

TABLE 5
Increasing Germination Rate of Corn Under Cold Conditions

| Treatment | Percent Germinated |
|---|---|
| Citric Acid and Polyethylene Glycol | 99 |
| Citric Acid and Sodium Bicarbonate | 97 |
| Control | 97 |

### Example 2: The Effects of Compositions of Citric Acid and Polyethylene Glycol and of Citric Acid and Sodium Bicarbonate on Germination Rates of Soybean Under Cold Conditions

308 soybean seeds per treatment were treated with a liquid treatment of 0.0008118%-0.02602% citric acid and 0.01132%-0.3627% (polyethylene glycol, or a liquid treatment of 0.0007392%-0.02366% citric acid and 0.00007392%-0.002366% sodium bicarbonate, or a Control treatment of the base only.

Seeds were then sowed and monitored for germination under cold conditions at 10° C. Percent germination was calculated by the number of seeds germinated divided by the total number of seeds planted. It was observed that citric acid and polyethylene glycol and citric acid and sodium bicarbonate increased germination rate of soybean, shown in Table 6.

TABLE 6
Increasing Germination Rate of Soybean Under Cold Conditions

| Treatment | Percent Germinated |
|---|---|
| Citric Acid and Polyethylene Glycol | 97 |
| Citric Acid and Sodium Bicarbonate | 95 |
| Control | 92 |

### Example 3: The Effects of Compositions of Citric Acid and Polyethylene Glycol and of Citric Acid and Sodium Bicarbonate on Germination Rates of Soybean Under Cold and Wet Conditions

Soybean seeds were treated with a liquid treatment of 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were sowed in trays on top of wet creped cellulose paper material and covered with non-sterile field soil. The cellulose paper maintains soil moisture at 60-70% water holding capacity of the soil. The trays were exposed to cold stress at 10° C. for 7 days and then transferred to ideal conditions for grow-out at 25° C. Seedlings were evaluated three and seven days after transfer for emergence and final germination assessments. Percent germination was calculated by the number of seeds germinated divided by the total number of seeds planted. It was observed that citric acid and polyethylene glycol and citric acid and sodium bicarbonate increased germination rate of soybean, shown in Table 7.

TABLE 7
Increasing Germination Rate of Soybean
Under Cold and Wet Conditions

| Treatment | Percent Germinated |
|---|---|
| Citric Acid and Polyethylene Glycol | 81 |
| Citric Acid and Sodium Bicarbonate | 79 |
| Control | 72.5 |

### Example 4: The Effects of Compositions of Citric Acid and Polyethylene Glycol and of Citric Acid and Sodium Bicarbonate on Germination Rates of Wheat Under Cold Conditions

Wheat seeds were treated with a liquid treatment of between 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under cold conditions, at 10° C. Percent germination was calculated by the number of seeds germinated divided by the total number of seeds planted. It was observed that citric acid and polyethylene glycol and citric acid and sodium bicarbonate increased germination rate of wheat, shown in Table 8.

TABLE 8
Increasing Germination Rate of Wheat Under Cold Conditions

| Treatment | Percent Germinated |
|---|---|
| Citric Acid and Polyethylene Glycol | 50.00 |
| Citric Acid and Sodium Bicarbonate | 50.00 |
| Control | 40.28 |

### Example 5: The Effects of Compositions of Citric Acid and Polyethylene Glycol and of Citric Acid and Sodium Bicarbonate on Germination Rates of Sorghum Under Cold Conditions

733 sorghum seeds per treatment were treated with a liquid treatment of between 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under cold conditions, 10° C. Percent germination was calculated by the number of seeds germinated divided by the total number of seeds planted. It was observed that citric acid and polyethylene glycol and citric acid and sodium bicarbonate increased germination rate of sorghum, shown in Table 9.

TABLE 9
Increasing Germination Rate of Sorghum Under Cold Conditions

| Treatment | Percent Germinated |
|---|---|
| Citric Acid and Polyethylene Glycol | 29.00 |
| Citric Acid and Sodium Bicarbonate | 60.00 |
| Control | 27.00 |

### Example 6: The Effects of Compositions of Citric Acid and Polyethylene Glycol and of Citric Acid and Sodium Bicarbonate on Germination Rates of Canola Under Cold Conditions

500 canola seeds per treatment were treated with a liquid treatment of between 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under cold condition at 10° C. Percent germination was calculated by the number of seeds germinated divided by the total number of seeds planted. It was observed that citric acid and sodium bicarbonate increased germination rate of canola, shown in Table 10.

TABLE 10
Increasing Germination Rate of Canola Under Cold Conditions

| Treatment | Percent Germinated |
|---|---|
| Citric Acid and Polyethylene Glycol | 75.0 |
| Citric Acid and Sodium Bicarbonate | 86.0 |
| Control | 79.0 |

### Example 7: The Effects of Compositions of Citric Acid and Polyethylene Glycol and of Citric Acid and Sodium Bicarbonate on Germination Rates of Corn Under Standard Conditions

336 corn seeds per treatment were treated with a liquid treatment of between 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under standard conditions. Percent germination was calculated by the number of seeds germinated divided by the total number of seeds planted. It was observed that citric acid and polyethylene glycol and citric acid and sodium bicarbonate increased germination rate of corn, shown in Table 11.

TABLE 11
Increasing Germination Rate of Corn Under Standard Conditions

| Treatment | Percent Germinated |
|---|---|
| Citric Acid and Polyethylene Glycol | 95.24 |
| Citric Acid and Sodium Bicarbonate | 96.73 |
| Control | 90.18 |

### Example 8: The Effects of Compositions of Citric Acid and Polyethylene Glycol and of Citric Acid and Sodium Bicarbonate on Germination Rates of Tomatoes Under Standard Conditions

638 tomato seeds per treatment were treated with a liquid treatment of between 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under standard conditions. Percent germination was calculated by the number of seeds germinated divided by the total number of seeds planted. It was observed that citric acid and polyethylene glycol and citric acid and sodium bicarbonate increased germination rate of corn, shown in Table 12.

TABLE 12
Increasing Germination Rate of Tomatoes
Under Standard Conditions

| Treatment | Percent Germinated |
|---|---|
| Citric Acid and Polyethylene Glycol | 95 |
| Citric Acid and Sodium Bicarbonate | 94 |
| Control | 85 |

### Example 9: The Effects of Compositions of Citric Acid and Polyethylene Glycol and of Citric Acid and Sodium Bicarbonate on Germination Rates of Cucumbers Under Standard Conditions

200 cucumber seeds per treatment were treated with a liquid treatment of 0.0008118%-0.02602% citric acid and 0.01132%-0.3627% polyethylene glycol, or a liquid treatment of 0.0007392%-0.02366% citric acid and 0.00007392%-0.002366% sodium bicarbonate, or a Control treatment of the base only.

Seeds were then sowed and monitored for germination under standard conditions. Percent germination was calculated by the number of seeds germinated divided by the total number of seeds planted. It was observed that citric acid and sodium bicarbonate increased germination rate of cucumber, shown in Table 13.

TABLE 13
Increasing Germination Rate of Cucumbers
Under Standard Conditions

| Treatment | Percent Germinated |
|---|---|
| Citric Acid and Polyethylene Glycol | 78.5 |
| Citric Acid and Sodium Bicarbonate | 81.5 |
| Control | 78.5 |

### Example 10: Effect of Treating Corn Seeds with a Seed Coating Containing Citric Acid and Polyethylene Glycol on Crop Yield

Liquid concentrate seed treatment slurry was made with 0.33% citric acid and 4.60% polyethylene glycol. The liquid concentrate was diluted into a base treatment with a total volume of 15 fluid ounces per hundredweight (floz/CWT). The base treatment contained 1.28 floz/CWTAlias 4F (imidacloprid), 5 floz/CWT Maxim Quattro (fludioxonil 3.32%, mefenoxam 2.65%, azoxystrobin 1.33%, thiabendazole 26.50%), Seedworx 6100x (film coating polymer), 1 floz/CWT Sensient Red (agricultural colorant) and water to bring up total volume to 15 floz/CWT liquid slurry. All components of the base seed treatment are within the use rates on the components' labels. Corn seeds of the hybrids 6469 VP, 5608LM, and 4117 AM were treated with a liquid treatment containing the base treatment, 0.0008118%-0.02602% citric acid and 0.01132%-0.3627% polyethylene glycol (“Treatment 1”), or only the base treatment (“Control”). Treatment 1 and Control contained the same amount of the base treatment. Seeds were treated by following industry standard protocols for liquid seed treatment coating using a Hege 11 liquid seed treater to create a uniform coating on each seed. After treatment, seeds of the corn hybrids 6469VP, 5608LM, and 4117AM were then sowed at five different field sites in Miami, MO, Sparta, IL, Nevada, IA, St. Joseph, MO, and DeGraff, MN, grown under conditions as standard for corn growing, and harvested. At harvest, yield was calculated as bushels per acre (Bu/Ac) and compared between the Control and Treatment 1. The average was calculated across all plot harvest yields for the Control and all plot harvest yields for Treatment 1. Treatment 1 showed an average increase in yield of 0.64 Bu/Ac over the Control average yield (Table 14).

TABLE 14
Increased crop yield after liquid treating corn
seeds with citric acid and polyethylene glycol

| Treatment | Bu/Ac | Change over Control |
|---|---|---|
| Control | 228.28 | n/a |
| Treatment 1 | 228.92 | +0.64 Bu/Ac |

### Example 11: Effect of Treating Corn Seeds with a Seed Coating Containing Citric Acid and Polyethylene Glycol on Emergence and Crop Yield after Cold Exposure

Liquid concentrate seed treatment slurry was made with 0.33% citric acid and 4.60% polyethylene glycol. The liquid concentrate was diluted into the base treatment of Example 10. All components of the base seed treatment are within the use rates on the components' labels. Corn seeds of the hybrid 4117 AM were treated with a liquid treatment containing the base treatment of Example 10, 0.0008118%-0.02602% citric acid and 0.01132%-0.3627% polyethylene glycol (“Treatment 1”), or only the base treatment (“Control”). Treatment 1 and Control contained the same amount of the base treatment. Seeds were treated by following industry standard protocols for liquid seed treatment coating using a Hege 11 liquid seed treater to create a uniform coating on each seed. After treatment, seeds were sowed in DeGraff, Minnesota, under cold conditions at approximately 12 degrees Celsius, and otherwise grown under conditions as standard for corn growing. During the VE stage of corn growth, emergence was measured at 3 different times as a count of corn plants that had emerged from the soil (“Emergence”) for Treatment 1 and Control. The first emergence measurement was taken 23 days after planting, at which time point Treatment 1 had an increase of 5% in emergence over Control (Table 15). The second emergence measurement was taken 28 days after planting, at which time Treatment 1 had an increase of 8% in emergence over Control (Table 15). The third emergence measurement was taken 34 days after planting, at which time Treatment 1 had an increase of 7% in emergence over Control (Table 15). At harvest, yield was calculated as bushels per acre (Bu/Ac) and compared between the Control and Treatment 1 (Table 15). Treatment 1 showed an increase in yield of 3.2% over the Control average yield (Table 15).

TABLE 15
Increased crop yield and emergence after cold exposure by liquid
treating corn seeds with citric acid and polyethylene glycol

| | | Change in | Change in | Change in |
|---|---|---|---|---|
| | | Emergence over | Emergence over | Emergence over |
| | Change in Yield | Control 23 days | Control 28 days | Control 34 days |
| Treatment | over Control | after planting | after planting | after planting |
| Treatment 1 | +3.2% | +5% | +8% | +7% |

### Example 12: Effect of Treating Soybean Seeds with a Pre-Planting Dry Seed Treatment Containing Citric Acid and Polyethylene Glycol on Crop Yield

Concentrated pre-planting dry seed treatment was made with 6.69% citric acid and 93.31% polyethylene glycol. This pre-planting dry seed treatment concentrate was diluted into a base 80:20 talc-graphite mixture (“base mixture” or “base treatment”) at a low treatment rate (“Treatment 2”) and high treatment rate (“Treatment 3”). Soybean seeds of the varieties Pioneer P30A75E, NK S26-E3, and Paloma Seed PL2E142 were treated with a pre-planting dry seed treatment containing the base mixture, 0.00722% (0.0039 grams per unit seed) citric acid and 0.1007% (0.0544 grams per unit seed) polyethylene glycol (“Treatment 2”) or the base mixture, 0.0144% (0.0078 grams per unit seed) citric acid and 0.2015% (0.1088 grams per unit seed) polyethylene glycol (“Treatment 3”), or only the base mixture (“Control”).

Treatment 2, Treatment 3 and Control contained the same amount of the base treatment. Pre-planting treatment was done by adding seeds and the appropriate pre-planting treatment to a grower's planter box, where the seeds and treatment were then mixed just prior to planting. After pre-planting treatment, the seeds were sown at three different field sites in Troy, OH, Frankfort, IN, and Toronto, SD, grown under conditions as standard for soybean growing, and harvested. At harvest, yield was calculated as bushels per acre (Bu/Ac) and compared between the Control, Treatment 2, and Treatment 3. The average was calculated across all plot harvest yields for the Control and all plot harvest yields for each Treatment 2 and Treatment 3. Treatment 2 showed an average increase in yield of 1.96 Bu/Ac over the Control average yield (Table 16). Treatment 3 showed an average increase in yield of 3.36 Bu/Ac over the Control average yield (Table 16).

TABLE 16
Increased crop yield after pre-planting dry treatment of
soybean seeds with citric acid and polyethylene glycol

| Treatment | Bu/Ac | Change over Control |
|---|---|---|
| Control | 64.36 | n/a |
| Treatment 2 | 66.32 | +1.96 |
| Treatment 3 | 67.72 | +3.36 |

### Example 13: Effect of Treating Soybean Seeds with a Pre-Planting Dry Seed Treatment Containing Citric Acid and Polyethylene Glycol on Canopy Cover

Concentrated pre-planting dry seed treatment was made with 6.69% citric acid and 93.31% polyethylene glycol. This pre-planting dry seed treatment concentrate was diluted into a base 80:20 talc-graphite mixture at a low treatment rate (“Treatment 2”) and high treatment rate (“Treatment 3”). Soybean seeds of the varieties Pioneer P30A75E, NK S26-E3, and Paloma Seed PL2E142 were treated with a pre-planting dry seed treatment containing the base mixture, 0.00722% (0.0039 grams per unit seed) citric acid and 0.1007% (0.0544 grams per unit seed) polyethylene glycol (“Treatment 2”) or the base mixture, 0.0144% (0.0078 grams per unit seed) citric acid and 0.2015% (0.1088 grams per unit seed) polyethylene glycol (“Treatment 3”), or only the base mixture (“Control”).

Treatment 2, Treatment 3 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sown at three different field sites in Troy, OH, Frankfort, IN, and Toronto, SD, grown under conditions as standard for soybean growing. At the approximate R1-R3 stage, drone footage of the test plots was taken and analyzed to determine canopy cover of the soybean plants. The drone footage was scored on a scale of 0 to 100 index points, where 100 was the best canopy cover, and average canopy cover scores (“Index Score”) were calculated for the Control, Treatment 2, and Treatment 3 test plots. Treatment 2 had an average canopy cover score 0.25 index points higher than the Control (Table 17). Treatment 3 had an average canopy cover score 1.03 index points higher than the Control (Table 17).

TABLE 17
Increased canopy cover after pre-planting dry treatment
of soybean seeds with citric acid and polyethylene glycol

| Treatment | Average Index Score | Change over Control |
|---|---|---|
| Control | 84.53 | n/a |
| Treatment 2 | 84.78 | +0.25 |
| Treatment 3 | 85.56 | +1.03 |

### Example 14: Effect of Treating Soybean Seeds with a Pre-Planting Dry Seed Treatment Containing Citric Acid and Polyethylene Glycol on Vigor

Concentrated pre-planting dry seed treatment was made with 6.69% citric acid and 93.31% polyethylene glycol. This pre-planting dry seed treatment concentrate was diluted into a base 80:20 talc-graphite mixture at a low treatment rate (“Treatment 2”) and high treatment rate (“Treatment 3”). Soybean seeds of the varieties Pioneer P30A75E, NK S26-E3, and Paloma Seed PL2E142 were treated with a pre-planting dry seed treatment containing the base mixture, 0.00722% (0.0039 grams per unit seed) citric acid and 0.1007% (0.0544 grams per unit seed) polyethylene glycol (“Treatment 2”) or the base mixture, 0.0144% (0.0078 grams per unit seed) citric acid and 0.2015% (0.1088 grams per unit seed) polyethylene glycol (“Treatment 3”), or only the base mixture (“Control”).

Treatment 2, Treatment 3 and Control contained the same amount of the base treatment. Pre-planting treatment was done by adding seeds and the appropriate pre-planting treatment to a grower's planter box, where the seeds and treatment were then mixed just prior to planting. After pre-planting treatment, the seeds were sown at three different field sites in Troy, OH, Frankfort, IN, and Toronto, SD, grown under conditions as standard for soybean growing. At the approximate R1-R3 stage, drone footage of the test plots was taken and analyzed to determine vigor of the soybean plants. The drone footage was scored on a scale of 0 to 100 index points, where 100 was the best vigor, and average vigor scores (“Index Score”) were calculated for the Control, Treatment 2, and Treatment 3 test plots. Treatment 2 had an average vigor index score of 1.34 index points higher than the Control (Table 18). Treatment 3 had an average vigor index score of 1.05 index points higher than the Control (Table 18).

TABLE 18
Increased plant vigor after pre-planting dry treatment of
soybean seeds with citric acid and polyethylene glycol

| Treatment | Average Index Score | Change over Control |
|---|---|---|
| Control | 81.87 | n/a |
| Treatment 2 | 83.21 | +1.34 |
| Treatment 3 | 82.92 | +1.05 |

### Example 15: Effect of Treating Soybean Seeds with a Pre-Planting Dry Seed Treatment Containing Citric Acid and Polyethylene Glycol on Height

Concentrated pre-planting dry seed treatment was made with 6.69% citric acid and 93.31% polyethylene glycol. This pre-planting dry seed treatment concentrate was diluted into a base 80:20 talc-graphite mixture at a high treatment rate (“Treatment 3”). Soybean seeds of the varieties Pioneer P30A75E, NK S26-E3, and Paloma Seed PL2E142 were treated with a pre-planting dry seed treatment containing the base mixture, 0.0144% (0.0078 grams per unit seed) citric acid and 0.2015% (0.1088 grams per unit seed) polyethylene glycol (“Treatment 3”), or only the base mixture (“Control”).

Treatment 3 and Control contained the same amount of the base treatment. Pre-planting treatment was done by adding seeds and the appropriate pre-planting treatment to a grower's planter box, where the seeds and treatment were then mixed just prior to planting. After pre-planting treatment, the seeds were sown at three different field sites in Troy, OH, Frankfort, IN, and Toronto, SD, grown under conditions as standard for soybean growing. At the approximate R1-R3 stage, drone footage of the test plots was taken and analyzed to determine the average height of the soybean plants in centimeters (“cm”). Average plant height was calculated for the Control and Treatment 3 test plots. In addition to the benefits in yield, vigor, and canopy cover, Treatment 3 also had an average height 2.14 cm higher than the Control (Table 19).

TABLE 19
Increased plant height after pre-planting dry treatment
of soybean seeds with citric acid and polyethylene glycol

| Treatment | Height (cm) | Change over Control |
|---|---|---|
| Control | 70.36 | n/a |
| Treatment 3 | 72.50 | +2.14 |

### Example 16: Effect of Treating Soybean Seeds with a Pre-Planting Dry Seed Treatment Containing Citric Acid, and Sodium Bicarbonate on Crop Yield

Concentrated pre-planting dry seed treatment was made with 90.91% citric acid and 9.09% sodium bicarbonate. This pre-planting dry seed treatment concentrate was diluted into a base 80:20 talc-graphite mixture to create the treatment rate (“Treatment 4”). Soybean seeds of the varieties Pioneer P30A75E, NK S26-E3, and Paloma Seed PL2E142 were treated with a pre-planting dry seed treatment containing the base mixture, 0.0066% (0.003545 grams per unit seed) citric acid, 0.00066% (0.0003545 grams per unit seed) sodium bicarbonate (“Treatment 4”) or only the base treatment (“Control”).

Treatment 4 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sown at three different field sites in Troy, OH, Frankfort, IN, and Toronto, SD, grown under conditions as standard for soybean growing, and harvested. At harvest, yield was calculated as bushels per acre (Bu/Ac) and compared between the Control and Treatment 4. The average was calculated across all plot harvest yields for the Control and all plot harvest yields for Treatment 4. Treatment 4 showed an average increase in yield of 1.98 Bu/Ac over the Control average yield (Table 20).

TABLE 20
Increased yield after pre-planting dry treatment of
soybean seeds with citric acid and sodium bicarbonate

| Treatment | Bu/Ac | Change over Control |
|---|---|---|
| Control | 64.36 | n/a |
| Treatment 4 | 66.34 | +1.98 |

### Example 17: Effect of Treating Soybean Seeds with a Pre-Planting Dry Seed Treatment Containing Citric Acid, and Sodium Bicarbonate on Canopy Cover

Concentrated pre-planting dry seed treatment in this example was made with 90.91% citric acid and 9.09% sodium bicarbonate. This pre-planting dry seed treatment concentrate was diluted into a base 80:20 talc-graphite mixture to create the treatment rate (“Treatment 4”). Soybean seeds of the varieties Pioneer P30A75E, NK S26-E3, and Paloma Seed PL2E142 were treated with a pre-planting dry seed treatment containing the base mixture, 0.0066% (0.003545 grams per unit seed) citric acid, 0.00066% (0.0003545 grams per unit seed) sodium bicarbonate (“Treatment 4”) or only the base treatment (“Control”).

Treatment 4 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sowed at three different field sites in Troy, OH, Frankfort, IN, and Toronto, SD, grown under conditions as standard for soybean growing. At the approximate R1-R3 stage, drone footage of the test plots was taken and analyzed to determine canopy cover of the soybean plants. The drone footage was scored on a scale of 0 to 100 index points, where 100 was the best canopy cover, and average canopy cover scores (“Index Score”) were calculated for the Control and Treatment 4 test plots. Treatment 4 had an average canopy cover score 2.28 index points higher than the Control (Table 21).

TABLE 21
Increased canopy after pre-planting dry treatment of
soybean seeds with citric acid and sodium bicarbonate

| Treatment | Average Index Score | Change over Control |
|---|---|---|
| Control | 84.53 | n/a |
| Treatment 4 | 86.81 | +2.28 |

### Example 18: Effect of Treating Soybean Seeds with a Pre-Planting Dry Seed Treatment Containing Citric Acid, and Sodium Bicarbonate on Height

Concentrated pre-planting dry seed treatment was made with 90.91% citric acid and 9.09% sodium bicarbonate. This pre-planting dry seed treatment concentrate was diluted into a base 80:20 talc-graphite mixture to create the treatment rate (“Treatment 4”). Soybean seeds of the varieties Pioneer P30A75E, NK S26-E3, and Paloma Seed PL2E142 were treated with a pre-planting dry seed treatment containing the base mixture, 0.0066% (0.003545 grams per unit seed) citric acid, 0.00066% (0.0003545 grams per unit seed) sodium bicarbonate (“Treatment 4”) or only the base treatment (“Control”).

Treatment 4 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sowed at three different field sites in Troy, OH, Frankfort, IN, and Toronto, SD, grown under conditions as standard for soybean growing. At the approximate R1-R3 stage, drone footage of the test plots was taken and analyzed to determine the average height of the soybean plants in centimeters (“cm”). Average plant height was calculated for the Control and Treatment 4 test plots. Treatment 4 had an average height 3.56 cm higher than the Control (Table 22).

TABLE 22
Increased canopy after pre-planting dry treatment of
soybean seeds with citric acid and sodium bicarbonate

| Treatment | Average Height (cm) | Change over Control |
|---|---|---|
| Control | 70.36 | n/a |
| Treatment 4 | 73.92 | +3.56 |

### Example 19: Effect of Treating Soybean Seeds with a Pre-Planting Dry Seed Treatment Containing Citric Acid, and Sodium Bicarbonate on Emergence

Concentrated pre-planting dry seed treatment was made with 90.91% citric acid and 9.09% sodium bicarbonate. This pre-planting dry seed treatment concentrate was diluted into a base 80:20 talc-graphite mixture to create the treatment rate (“Treatment 4”). Soybean seeds of the varieties Pioneer P30A75E, NK S26-E3, and Paloma Seed PL2E142 were treated with a pre-planting dry seed treatment containing the base mixture, 0.0066% (0.003545 g per unit seed) citric acid, 0.00066% (0.0003545 g per unit seed) sodium bicarbonate (“Treatment 4”) or only the base treatment (“Control”).

Treatment 4 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sowed at three different field sites in Troy, OH, Frankfort, IN, and Toronto, SD, grown under conditions as standard for soybean growing. At the stage of approximately 50% emergence, the number of plants emerged per acre (“Emergence”) was measured. The average emergence per acre was calculated for the Control and Treatment 4 test plots. Treatment 4 had an average emergence per acre of 3,989.56 more plants than the Control (Table 23).

TABLE 23
Increased emergence after pre-planting dry treatment of
soybean seeds with citric acid and sodium bicarbonate

| Treatment | Average Emergence (plants) | Change over Control |
|---|---|---|
| Control | 68,917.45 | n/a |
| Treatment 4 | 72,907.01 | +3,989.56 |

### Example 20: Effect of Treating Soybean Seeds with a Pre-Planting Dry Seed Treatment Containing Citric Acid, and Sodium Bicarbonate on Vigor

Concentrated pre-planting dry seed treatment was made with 90.91% citric acid and 9.09% sodium bicarbonate. This pre-planting dry seed treatment concentrate was diluted into a base 80:20 talc-graphite mixture to create the treatment rate (“Treatment 4”). Soybean seeds of the varieties Pioneer P30A75E, NK S26-E3, and Paloma Seed PL2E142 were treated with a pre-planting dry seed treatment containing the base mixture, 0.0066% (0.003545 g per unit seed) citric acid, 0.00066% (0.0003545 g per unit seed) sodium bicarbonate (“Treatment 4”) or only the base treatment (“Control”).

Treatment 4 and Control contained the same amount of the base treatment. Pre-planting treatment was done by adding seeds and the appropriate pre-planting treatment to a grower's planter box, where the seeds and treatment are then mixed just prior to planting. After pre-planting treatment, the seeds were sowed at three different field sites in Troy, OH, Frankfort, IN, and Toronto, SD, grown under conditions as standard for soybean growing. At the approximate R1-R3 stage, drone footage of the test plots was taken and analyzed to determine vigor of the soybean plants. The drone footage was scored on a scale of 0 to 100 index points, where 100 was the best vigor, and average vigor scores (“Index Score”) were calculated for the Control and Treatment 4 test plots. Treatment 4 had an average vigor score 0.8 index points higher than the Control (Table 24).

TABLE 24
Increased vigor after pre-planting dry treatment of
soybean seeds with citric acid and sodium bicarbonate

| Treatment | Average Index Score | Change over Control |
|---|---|---|
| Control | 81.87 | n/a |
| Treatment 4 | 82.67 | +0.8 |

In view of the above, it will be seen that the several objects of the invention are achieved and other advantageous results attained.

As various changes could be made in the above compositions, methods, and seeds, without departing from the scope of the invention, it is intended that all matter contained in the above description shall be interpreted as illustrative and not in a limiting sense.

1. An agricultural composition for protecting a plant, plant part, and/or plant seed from cold temperatures, drought conditions, and/or promoting germination wherein the composition comprises:
about 0.2 to about 0.4% citric acid based on the total weight per volume (w/v) of the composition; and
either one or both of the following:
about 4.0 to about 5.0% polyethylene glycol based on the total weight per volume (w/v) of the composition; and/or
about 0.01 to about 0.10% sodium bicarbonate based on the total weight per volume (w/v) of the composition.

2. The agricultural composition of claim 1, wherein the composition further comprises a pesticide, a preservative, a seed fluency agent, a biopolymer, or a combination thereof.

3. The agricultural composition of claim 2, wherein the pesticide comprises a fungicide, an insecticide, a nematicide, a molluscicide, an arachnicide, or a combination thereof.

4. The agricultural composition of claim 3, wherein the fungicide comprises:
a strobilurin, a conazole, a triazole, a strobin, a methyl benzimidazole carbonate, a succinate dehydrogenase inhibitor, phenylpyrrole, a phenylamide, or a combination thereof; or
pyraclostrobin, picoxystrobin, metconazole, cyproconazole, fenbuconazole, azoxystrobin, trifloxystrobin, or a combination thereof.

5. (canceled)

6. The agricultural composition of claim 3, wherein:
the insecticide comprises clothianidin, imidacloprid, cyantraniliprole, spinetoram, chlorantraniliprole, malathion, dimethoate, sevin, baythroid, danitol, lannate, admire, assail, pencycuron, etacyflutrhin, fipronil, fludioxinil, thiamethoxam, carbofuran, carbosulfan, an organophosphate, a carbamate, a pyrethroid, an neonicotinoid or a combination of any thereof; or
the nematicide comprises Bacillus firmus, fluopyram, abamectin, acetoprole, fluazaindolizine, pydiflumetofen, aldicarb, acephate, aldoxvcarb, acibenzolar-S-methyl, azadirachtin, carbosulfan, chlorfenapyr, oxamyl, benfuracarb, thiodicarb, fanamiphos, fenamiphos, fensulfothion, thoprofos, cadusafos, terbufos, fosthiazate, phorate, imicyafos, abamectin, cyclobutriluram, spirotetramat, fufural, fluensulfone, fluazaindolizine, iprodione, carbon disulfide, sodium tetrathiocarbonate, methyl bromide, methyl iodide, 1,2-dibromo-3-cholorpropane, ethylene dibromine, 1,3-diochloropropene, chloropicrin, dazometallyl isothiocyanate, allyl isothiocyanate, ivermectine, 1,2-dibromo-3-chloropropane, ethoprop, thiodicarb, metam potassium, metam sodium, tioxazafen, chitin, chitosan, curcumin, harpin protein, cis-jasmone, Quillaja extract, sesame loil, mustard seed meal, 1,4-naphthoquinone, juglone, a biologically-based nematicide, Bacillus-based nematicides, Purpureocillium-based nematicides, Paecilomyces-based nematicides, Pasteuria-based nematicides, Pochonia-based nematicides, Burkaholderia-based nematicides, Streptomyces-based nematicides, Trichoderma-based nematicides, Myrothecium-based nematicides, a bacterial extract, a fungal extract, a botanical extract, or a combination any thereof; or
the seed fluency agent comprises talc, graphite, or a combination thereof; or
the biopolymer comprises polyester, polyvinyl alcohol, polysaccharide, or a combination thereof.

7.-9. (canceled)

10. The agricultural composition of claim 1, wherein
the composition comprises:
citric acid and polyethylene glycol; or
citric acid and sodium bicarbonate; or
citric acid, polyethylene glycol and sodium bicarbonate; or
citric acid, polyethylene glycol, and 1,2-benzisothiazol-3-one; or
citric acid, sodium bicarbonate, and 1,2-benzisothiazol-3-one; or
citric acid, polyethylene glycol, and talc; or
citric acid, polyethylene glycol, talc, and graphite; or
citric acid, sodium bicarbonate and talc; or
citric acid, sodium bicarbonate, talc, and graphite.

11. The agricultural composition of claim 1, wherein the composition is diluted about 10-fold to about 5,000-fold, or about 10-fold to 2,500-fold, or about 10-fold to about 1,000-fold, or about 10-fold to about 500-fold, or about 12-fold to about 406-fold.

12. The agricultural composition of claim 1 wherein the composition consists essentially of citric acid, and either one or both of the polyethylene glycol and/or the sodium bicarbonate.

13. The agricultural composition of claim 1 wherein the composition consists of citric acid, and either one or both of the polyethylene glycol and/or the sodium bicarbonate.

14. A solid agricultural composition for protecting a plant, plant part, and/or plant seed from cold temperatures, drought conditions, and/or promoting germination wherein the composition comprises:
about 5% to about 15% citric acid based on the total weight per weight (w/w) of the composition; and
about 85% to about 95% of polyethylene glycol based on the total weight (w/w) of the composition.

15. A solid agricultural composition for protecting a plant, plant part, and/or plant seed from cold temperatures, drought conditions, and/or promoting germination wherein the composition comprises:
about 80% to about 95% citric acid based on the total weight per weight (w/w) of the composition; and
about 5% to about 20% of sodium bicarbonate based on the total weight (w/w) of the composition.

16. The solid agricultural composition of claim 14, wherein the composition is diluted in a seed fluency agent at a rate from about 10-fold to about 15,000-fold, from about 15-fold to about 10,000-fold, from about 50-fold to about 8,000-fold, or from about 100-fold to about 5,000-fold, or from about 250-fold to about 3,500-fold.

17. The solid agricultural composition of claim 15, wherein the composition is diluted in a seed fluency agent at a rate from about 100-fold to about 150,000-fold, from about 250-fold to about 125,000-fold, from about 500-fold to about 100,000-fold, or from about 1,000-fold to about 60,000-fold, or from about 3,800-fold to about 53,000-fold.

18. The solid agricultural composition of claim 16, wherein the seed fluency agent is talc or graphite.

19. An agricultural composition for protecting a plant, plant part, and/or plant seed from cold temperatures, drought conditions, and/or promoting germination, wherein the composition comprises sodium citrate and a fungicide, insecticide, preservative, nematicide, seed fluency agent, biopolymer, or any combination thereof.

20.-26. (canceled)

27. A plant seed coated with a composition of claim 1.

28. A plant seed coated with an agricultural composition comprising sodium citrate.

29. (canceled)

30. A method for protecting a plant, plant part, and/or plant seed from cold temperatures, drought conditions, and/or promoting germination, wherein the method comprises:
treating plant seeds with the composition of claim 1 prior to planting the seeds; or
treating an area of plant growth medium surrounding the plant seeds with the composition of claim 1.

31. (canceled)

32. A method for protecting a plant, plant part, and/or plant seed from cold temperatures, drought conditions, and/or promoting germination comprising applying a composition to the plant seed or an area of plant growth medium surrounding the plant seed, wherein the composition comprises sodium citrate.

33. The method of claim 30, wherein the plant seeds are from plants comprising core crops, vegetables, fruits, trees, fiber crops, oil crops, tuber crops, coffee, flowers, legumes, and cereals.

34. The method of claim 30, wherein the plant seeds are from plants comprising peanut, tobacco, cotton, soybean, corn, grasses, wheat, barley, rye, sorghum, rice, rapeseed, sugar beet, sunflower, tomato, pepper, bean, lettuce, potato, carrot, apples, pears, citrus fruits, and grapes.

35. The method of claim 30, wherein the plant seeds are genetically modified.

36. (canceled)

37. A method for extending life of a plant seed, the method comprising treating the plant seed or an area of plant growth medium surrounding the plant seed with an agricultural composition of claim 1.
